(19) United States
(12) Patent Application Publication
(10) Pub. No.: US 2014/0270502 A1
(43) Pub. Date: Sep. 18, 2014

(54) MODELED ATMOSPHERIC CORRECTION OBJECTS

(71) Applicant: DIGITALGLOBE, INC., (US)

(72) Inventors: VICTOR H. LEONARD, BRIGHTON, CO (US); FABIO PACIFICI, LONGMONT, CO (US)

(73) Assignee: DIGITALGLOBE, INC., LONGMONT, CO (US)

(21) Appl. No.: 13/844,309

(22) Filed: Mar. 15, 2013

(51) Int. Cl. G06T 5/50; G06T 7/00

(52) U.S. Cl. CPC G06T 5/50; G06T 7/0046
USPC 382/165; 382/274; 382/201

(57) ABSTRACT

Techniques for making, using and updating a Modeled Atmospheric Correction Object (MACO) cluster and the MACO sites that are selected from within a given MACO cluster. The MACO construct is a novel application of a Model of Reality (MOR) that provides synthetic ground truth essential to converting imagery from top-of-the-atmosphere radiance to surface reflectance given a variety of spatial, spectral and radiance effects involving non-uniform distributions of opaque clouds, cirrus clouds, aerosols, water vapor, surface ice, surface snow, shadows and bidirectional reflectance distribution function (BRDF) effects.

### BACKGROUND

The use of satellite-based and aerial-based imagery is popular among government and commercial entities. One of the challenges in obtaining high quality images of the earth is the presence of the atmosphere between the surface of the earth and the satellite collecting the image. This atmosphere has water vapor and aerosols therein that can cause the scattering of light, as well as clouds that can occlude ground areas that otherwise might be images. In addition, clouds can also block sunlight from directly illuminating areas that are being imaged.

Highly accurate classification of landcover types and states is essential to extracting useful information, insight and prediction for a wide variety of remote sensing applications. In many cases, this classification of type and state is dependent on multi-temporal observations. Remotely sensed measurements corrected to units of reflectance (ratio of incident electromagnetic energy to reflected energy) depend on properties of the material, while measurements of radiance (quantity of electromagnetic energy) are affected by numerous external environmental variables. Therefore, correction to reflectance is crucial for quantitative and multi-temporal applications.

In all cases, there are a number of confounding factors to deal with including opaque clouds, cirrus clouds, aerosols, water vapor, ice, snow, shadows, bidirectional reflectance distribution factor (BRDF) effects and transient coverings like water, dust, snow, ice and mobile objects. Pseudo invariant objects (PIOs) are often used for on-orbit calibration of relatively stable sensors because the PIOs are in useful states often enough. But there are not enough truly stable PIOs in the world with required spatial density to deal with the highly variable confounding factors of images.

### SUMMARY

Disclosed herein is a method of creating modeled atmospheric correction objects. The method includes accessing a plurality of images of the Earth's surface to identify patches thereof that are relatively homogeneous and are likely to change over time in a predictable manner; and storing metadata associated with the patches including geographic coordinates of the patches, the angular position from which the image was captured, and the time and date that the image was captured.

The method may further include determining the surface reflectance for the patches. The surface reflectance for a portion of the patches may vary seasonally.

Also disclosed is a method of using modeled atmospheric correction objects (MACO). The method includes providing a plurality of MACO sites that are cross-referenced by geographic coordinates; obtaining an image of a portion of the surface of the Earth, for which geographic coordinates of the surface area covered by the image are known; and identifying MACO sites within the image based on geographic coordinates.

The method may further include determining which of the identified MACO sites are visible in the image and using the visible MACO sites to compute atmospheric parameters. The method may further include updating information associated with each visible MACO site.

Also disclosed is a method of detecting whether or not a MACO site is impacted by transient conditions (e.g., cloud shadow, structure shadow, wetness, or snow cover).

The method may further include determining which of the conditions impact the MACO site (e.g., may use green-yellow-red or green-red band signatures).

Also disclosed is a method of altering the observed MACO site radiance to compensate for shadow effects to enable comparisons with expected reflectance.

### BRIEF DESCRIPTION OF THE DRAWINGS

The disclosure herein is described with reference to the following drawings, wherein like reference numbers denote substantially similar elements:

FIG. 1 is table of MACO classes and states.

FIG. 2 is an illustration of MACO clusters in an urban park.

FIG. 3 is an illustration of potential MACO sites.

FIG. 4 is an illustration of image-to-image variance in pixel positions.

FIG. 5 is a graph of the reflectance signature of four materials in the annual crop cycle.

FIG. 6 is a graph showing month-to-month signatures.

FIG. 7 are a set of graphs that show how various amounts of aerosols affect the signature of three different types of ground materials.

FIG. 8 is a flow diagram showing the main algorithm.

FIG. 9 is a flow diagram of a portion of the main algorithm.

FIG. 10 is an illustration of a satellite collecting images of the Earth's surface and communicating data to a ground station.

### DETAILED DESCRIPTION

While the embodiments disclosed herein are susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives of embodiments of the invention as defined by the claims. The disclosure is described with reference to the drawings, wherein like reference numbers denote substantially similar elements.

Prior art makes simplifying assumptions as to the presence and stability of calibrating materials, and the uniformity of atmospheric effects that introduce significant errors across images. We have determined that ignoring the dynamic phenological variations and atmospheric element gradients within a scene can create classification errors of 45% or more. Multi-temporal anomaly detection suffers accordingly.

FIG. 10 shows a platform 20, such as a satellite, sensing light coming thereto from the direction of a target 22. The image sensor in the satellite or aerial vehicle measures the radiance (light energy) received at the sensor. Of course, the radiance received is a function of the position of the sun 24, the position of the satellite, the atmosphere conditions (including the presence of clouds) and other factors. It is desirable to instead have the surface reflectance as opposed to the radiance received at the satellite, as it is a better indicator of the ground area to know how it reflects light as compared to how the ground area looks from the top-of-the-atmosphere with all the various atmospheric parameters affecting the image. The platform 20 can communicate with a ground station 26 to send image data thereto. The ground station 26 may perform various processing and/or storage of the image data and/or it may send the image data to other locations for processing and/or storage.

What are MACO Objects?

MACO clusters are effectively homogeneous clusters on the earth that are predictable enough that they can be used as estimators of ground truth in atmospheric correction inversion processes. MACO sites are interior patches within each MACO cluster ranging in size from as small as 2m×2m to as large as 60m×60m.

MACO clusters generally change throughout a year, but they do so in relatively predictable ways depending on their land use and how they interact with humans and their environments. We extend the general definition of phenotypes to this broader context. FIG. 1 shows the currently defined MACO phenotypes. Each MACO cluster is classified as one of the established types of calibration, stable or dynamic MACO as typified in FIG. 1.

FIG. 2 shows a notional example of MACO clusters in the context of an urban park. The phenotypes for this example include deciduous forests, coniferous forests, rangeland, irrigated grasses, parking lot and a lake. Note that some areas within the park are potentially unsuitable because they are too heavily mixed or are likely to be covered by randomly distributed transient objects such as people, animals, and vehicles.

The projection of pixels from a sensor defines the boundaries of potential MACO sites. To be useful, most MACO sites need to be interior to the MACO cluster so that they have a reasonable probability of being homogeneous. There can be many reasons why a potential MACO site may not actually survive an arduous vetting process to become part of a control model. Those reasons are outlined in the discussion below. FIG. 3 shows an example of potential MACO sites that were actually selected (red tiles) based on proximity to MACO cluster boundaries and other factors. Note that the rest of the potential MACOS sites were not selected (clear tiles).

Although MACO cluster boundaries are fairly constant over time, potential MACO site boundaries are defined by the projection of sensor pixels onto the MACO clusters for a given image. FIG. 4 shows how selected MACO sites and site boundaries can vary in position and registration relative to the parent MACO cluster from image to image. This is simply due to variations from image to image due to the actual timing of the imaging operations and the exact location and attitude of the collection platform at the time.

The role that MACO sites play is elegantly simple in that they model the expected multi-spectral reflectance signature that should be obtained after all corrections are made. Differences between the expected reflectance signature values for each spectral band in a given MACO site and the surface reflectance estimate are related directly to the effects that must be corrected, albeit in a complex way. Atmospheric correction parameters can be generated using multiple MACO sites and other references within an image to create a surface reflectance value for each band at each pixel within the image under investigation.

MACO clusters are members of a diverse class of Models of Reality (MORs) that have three essential properties:
They represent fairly common land uses/land cover (LULC) types and as a result, nearly every square kilometer patch of the earth land surface has the potential to contain at least one MACO class object.
Their state and appearance in the near future can be a reasonably estimated, given a recent estimate of their state and appearance, because their phenological behaviors follow well known progressions over time.
They are big enough in extent that relatively pure, interior MACO site candidates within each MACO cluster or region can be identified and compared to other sites to verify their suitably for ground truth use.

MACO clusters fall into three distinct unmixed classes (see FIG. 1) and one mixed class:
Calibration MACO clusters are the previously mentioned PIOs located in very specific places in the world. Examples include White Sands Missile Range (WSMR), NM, Railroad Valley and Lunar Lake, N. Mex., Barreal Blanco, Argentina, regions of the Saharan Desert, and others. These locations tend to have minimal atmospheric effects or transient coverings often enough that they can be used for absolute calibration and characterization of longer term drift in sensors.
Stable MACO clusters include expanses of barren land, coniferous trees, deep water, crushed rock, asphalt and concrete. The biological members of this class can go through modelable changes in appearance due to diurnal and seasonal effects. Transient coverings are easily detected using geography, time of year, weather and temperature records, and comparisons of observed spectral and spatial properties with known signature libraries.
Dynamic MACO clusters include expanses of grass fields, broad area agriculture fields, parking lots and shallow water. The biological members of this class can go through fairly radical changes in appearance due to diurnal and seasonal effects. In a single year, a field of rotated corn or soybean, for example, can go from snow covered, to mixed soil and old harvest trash, to freshly tilled soil, to mixed soil and plants, to full canopy closure, to tasseling, to senescence, to harvesting, to mixed soil and harvest trash. Even though there is a lot of change, in one sense the progression is deterministic enough that errors in estimation of phenological phase, and physiological state are small compared to the positive benefit of the estimations of atmospheric conditions they enable. Transient coverings are easily detected using geography, time of year, weather and temperature records, and comparisons of observed spectral and spatial properties with known signature libraries.
Mixed MACO clusters are the size of a MACO site. They are not homogenous. They are generated for a given image by estimating the spectral signature resulting from a linear combination of endmembers whose associated abundances are calculated directly from the observed fine spatial resolution panchromatic and multi-spectral imagery. The intent is to use this class of MACO sparingly until a sufficiently robust MACO library is established.

How are MACO Clusters Created?

MACO clusters are created by mining large global libraries of imagery looking for patches of earth that seem to change in predictable ways throughout the year. Large patches that show consistent group behavior are tessellated into roughly 300 m by 300 m or smaller MACO clusters. For each MACO cluster, we determine the basic MACO phenotype (see FIG. 1) and the various endmembers that are observed throughout the year. We obtain the nominal BRDF for each endmember from available sources, physical modeling and/or custom field measurements.

How are MACO Sites Prepared for Radiance-to-Reflectance Conversion Applications?

This section describes how specific MACO sites are selected and readied for use in external processes. FIGS. 8 and 9 describe the general flow.

Step 1 is to identify which MACO clusters and potential MACO sites are relevant to characterizing the atmospheric conditions and general states of the pixels in a given image. MACO clusters are either established prior to use, or may arise spontaneously for temporary use.

Established MACO clusters are already in the MACO Library, which can be searched to locate those MACO clusters that are interior to, or exterior, but proximate to an image boundary. Those MACO clusters that meet the criteria are included in the MACO Cluster List (MCL) for the image. Established MACO clusters are generally preferred because the essence of being an established MACO is that it is possible to make reasonably good predictions.

Temporary MACO clusters arise when either the established MACO clusters do not provide a dense enough mapping of candidate MACO sites to begin with within a sub-region of an image or because significant portions of established MACO clusters are impacted by transient effects such as snow. Homogeneous patches are identified within the low density sub-regions and then subjected to suitable radiance-to-reflectance (RTR) conversion functions using proximate MACO sites to drive the process. RTR conversion processes are not part of this invention.

The resultant spectral signature of the homogenous patch is then compared to the Master Signature Library. If there is a signature match, then a temporary MACO is created and added to the MCL for the image. The temporary MACO is also flagged for external consideration as a newly established MACO. If there is not a signature match, then the homogeneous patch is also flagged for external analysis and potentially its signature may be added to the Master Signature Library.

Every potential interior MACO site for each MACO cluster in the MCL is placed in the MACO Site List (MSL) for the image. The utility of each MACO site in the MSL is set initially to “useful” and as the processing progresses, the status of a number of the MACO sites in the MSL will be set to “rejected”.

Step 2 is to determine whether or not each MACO site in the MSL can be seen or not, i.e., is it blocked by an opaque cloud or a physical structure of some kind? The process to determine if it is blocked is not part of this invention. If the MACO site is blocked then we mark that MACO site as “rejected” and it will not participate in further correction processes for this image.

Step 3 is to establish the initial estimate of the expected endmember and state for each MACO site in the MSL. The expected endmember (e.g., corn) and state (e.g., growing/healthy) is updated for the current date based on the prior endmember and state, and elapsed time since the prior update. The nominal signature and BRDF for each endmember is retrieved for each MACO site in the MSL for use as the initial estimate of the expected reflectance using the sensor look and solar illumination vectors at the MACO site center for the date and time that it was imaged.

Step 4 involves a two pass process to determine utility and key parameters for each MACO site in the MSL. The first pass of Step 4 determines which of the useful MACO sites in the MSL are still useful and makes a gross correction to their expected endmembers, states and other parameters. The second pass refines the expected endmember, states and other parameters.

Step 4a determines if “useful” MACO sites in the MSL are impacted by one of several transient conditions, e.g., cloud shadow, structure shadow, wetness, or snow cover. FIG. 5 shows the reflectance of four materials that are commonly part of the annual crop cycle. FIG. 6 shows how they might mix during the year to produce various signatures. FIG. 7 provides part of the evidence that to a first order, aerosol effects do not alter the green, yellow or red signature enough for three common land covers, e.g., green grass, coniferous trees and deciduous trees to be confused with snow or crop field endmembers, shadowed or not. Shadows can in some cases be less bright than in direct sunlight and slightly more bluish, depending on a number of conditions. Shadows can be relatively brighter if there is a lot of high level haze or there are proximate, highly reflective buildings and/or clouds.

So, we can determine whether or not we have shadows or no shadows on the nominal MACO site material or snow. Snow tends to be very flat between the green and red bands. Even if there is shadow on snow, the resultant green-yellow-red (or green-red) curve would not match the curves for sunlit soil, green grass or dry grass. Shadowed soil, green grass and dry grass are not likely to be confused by shadowed snow or each other. We can detect wetness conditions by comparing the dry and wet variants of the endmember and their respective BRDF. If we have good agreement with either the wet or dry variants, then we pick the best fitting endmember.

Step 4b updates the transient conditions parameters for each MACO site in the MSL, e.g., cloud shadow, structure shadow, wetness, snow cover, dust cover. The presence of wetness, snow cover and/or dust is admissible for MACO sites, but it is necessary to reset the expected endmember and state parameters for the MACO site accordingly. The expected reflectance and actual observed radiance for all non-shadowed, non-rejected MACO sites are updated.

Step 4c addresses special corrections for shadowed MACO site in the MSL. MACO sites are only useful as a set for atmospheric correction if they are consistent with sunlit conditions. If a given MACO site is shadowed, we assume that the expected reflectance is valid. But we need to alter the observed MACO site radiance signature from its darker shadowed state to a modeled sunlit state by using a simple function that effectively brightens each band in such a way to as to restore the effect of direct sunlight, including reversal of the bluish effect in the shadows. The expected reflectance and modeled sunlit observed radiance are updated for those shadowed MACO sites.

Step 4d does a validity check for each MACO site in the MSL. For each MACO cluster in the MCL for the image, the entire set of MACO sites in that MACO cluster are then compared to each other using the green-yellow-red (or green-red) signatures. Any MACO site that is not in approximately the same spectral state as the spectral state of the largest group of MACO sites, after shadow compensation if appropriate, is rejected from further consideration as a MACO site in the MSL. This process keeps transient effects like vehicles, fire damage, disease, etc., from corrupting the process.

Step 4e estimates the essential atmospheric correction parameters for each “still useful” MACO site in the MSL. Because each useful MACO site is a “known endmember” in a “known” state, an inversion process is used to estimate the essential atmospheric correction parameters that would explain the discrepancy between the expected MACO's reflectance and the retrieved reflectance.

Step 4f updates a software model for the given image by storing the state parameters (e.g., location, BRDF, expected signature) and essential atmospheric correction parameters for each useful MACO site in the MSL. The model enables fine spatial fidelity radiance-to-reflectance correction processes in external atmospheric correction algorithms.

Step 4g manages the two estimation passes. Once the first pass at estimating atmospheric conditions is done for the useful MACO sites, the second pass of the two pass process is executed using the first pass corrected reflectance signature for the useful MACO sites in the MSL as the starting expected signature instead of the nominal signature and BRDF. At the completion of the second pass, the state of the model for the given image is kept as the final.

How are MACO Clusters Maintained?

Final computed reflectance signatures corresponding to the specific imaging time are stored along with the BRDF geometries for each useful MACO site in the MSL and each MACO cluster in the MCL. To the extent practical, the multispectral signatures are used to adjust the hyperspectral signatures for the MACO sites, enabling their use by other collection platforms. An estimate is made of the most probable phenological and physiological state at that time and physical and/or empirical models based on time (phenology), BRDF geometries, and physiological state for the specific MACO material are updated accordingly to facilitate prediction of most probable states at next imaging event.

One application of the MACO techniques described herein is disclosed in concurrently-filed U.S. patent application Ser. No. 13/840,743, entitled “Atmospheric Compensation in Satellite Imagery” identified in the law firm of Marsh Fischmann & Breyfogle LLP as 50224-00224, the contents of which are incorporated herein by reference.

While the embodiments of the invention have been illustrated and described in detail in the drawings and foregoing description, such illustration and description are to be considered as examples and not restrictive in character. For example, certain embodiments described hereinabove may be combinable with other described embodiments and/or arranged in other ways (e.g., process elements may be performed in other sequences). Accordingly, it should be understood that only example embodiments and variants thereof have been shown and described.

We claim:

1. A method of creating modeled atmospheric correction objects, comprising:
accessing a plurality of images of the Earth's surface to identify patches thereof that are relatively homogeneous and are likely to change over time in a predictable manner; and
storing metadata associated with the patches including geographic coordinates of the patches, the angular position from which the image was captured, and the time and date that the image was captured.

2. A method as defined in claim 1, further including determining the surface reflectance for the patches.

3. A method as defined in claim 1, wherein the surface reflectance for a portion of the patches varies seasonally.

4. A method of using modeled atmospheric correction objects (MACO), comprising:
providing a plurality of MACO sites that are cross-referenced by geographic coordinates;
obtaining an image of a portion of the surface of the Earth, for which geographic coordinates of the surface area covered by the image are known; and
identifying MACO sites within the image based on geographic coordinates.

5. A method as defined in claim 4, further including:
determining which of the identified MACO sites are visible in the image; and
using the visible MACO sites to compute atmospheric parameters.

6. A method as defined in claim 5, further including:
updating information associated with each visible MACO site.

7. A method of detecting whether or not a MACO site is impacted by transient conditions (e.g., cloud shadow, structure shadow, wetness, or snow cover) (see paragraphs 0057 and 0058).

8. A method as defined in claim 7, further including determining which of the conditions impact the MACO site (see paragraph 0057) (may use green-yellow-red or green-red band signatures).

9. A method of altering the observed MACO site radiance to compensate for shadow effects to enable comparisons with expected reflectance (see paragraph 0056).
